(19) United States
(12) Patent Application Publication
(10) Pub. No.: US 2005/0109433 A1
(43) Pub. Date: May 26, 2005

(54) High-strength steel component with zinc containing corrosion resistant layer

(75) Inventors: Elisabeth Danger, Paderborn (DE); Matthias Kroger, Brakel (DE)

Correspondence Address: THE FIRM OF KARL F ROSS, 5676 RIVERDALE AVENUE, PO BOX 900, RIVERDALE (BRONX), NY, 10471-0900, US

(73) Assignee: Benteler Automobiltechnik GmbH

(21) Appl. No.: 10/962,982

(22) Filed: Oct. 12, 2004

(30) Foreign Application Priority Data
Oct. 13, 2003 (DE) 10348086.2

(51) Int. Cl. B32B 15/00; C23C 8/36

(52) U.S. Cl. 148/533; 428/659

(57) ABSTRACT

A hot-pressed and in-tool hardened structure or safety component of a vehicle is treated with zinc dust or powder to affect zinc diffusion into the steel surface and from a zinc/iron alloy with corrosion resistance. The thickness of the coating is up to 10 μm.

### FIELD OF THE INVENTION

The present invention relates to a method for making a high-strength corrosion steel component as a structural member of an automotive vehicle or as a safety-promoting member. More particularly this invention relates to a hot-formed and press hardened structural or safety component for a motor vehicle composed of high-strength steel with a corrosion resistant layer containing zinc.

### BACKGROUND OF THE INVENTION

In vehicle construction, structural components and safety components are increasingly being fabricated from high-strength steel. In order to provide optimum strength with lightweight constructions, high-strength steel blanks may be fabricated into shaped structural steel and safety components for a motor vehicle by die pressing in a hot state (hot forming) followed by press hardening, i.e. hardening of the hot formed component in the die (in-tool hardening). Such techniques can be used for components like door impact beams, the A columns and B columns of an automotive vehicle, a shock absorber longitudinal or transverse beam (cross beam), and other structural and safety components of the vehicle.

DE 24 52 486 C2, for example, describes a method for the press forming and hardening of steel sheet of relatively small material thickness to produce shaped bodies of high dimensional stability. The steel is a boron-alloy steel and is heated to a temperature above the A_{c3} temperature and shaped to the desired final configuration in less than 5 seconds between a pair of die members. While retaining the shaped body between these members, the body is cooled rapidly by the indirect cooling of the die to produce a martensitic and/or bainitic structure in the steel.

The A_{c3} temperature is, of course, the temperature at is which the ferrite to austenite transition is complete on the heating of such a steel. Under these conditions, it is possible to obtain a product with high shape retentivity and dimensional stability, a precise configuration and a high-strength such that the fabricated component is particularly suitable for use as a structural member in a steel body of an automotive vehicle or as a safety or crash impact absorbing component thereof.

One problem with such hot-formed, press-hardened structural and safety components has been, however, the corrosion resistance thereof. From DE 101 58 622 A1 it is known, for example, to apply a layer which is strongly adherent to the steel component to serve as a corrosion-resistant coating. The usual coating technique is a melt immersion process, for example, a pyrogalvanisation in which zinc is applied from a bath. Other techniques utilize galvanic application of the zinc from an electrolyte or thermal spraying. A cold gas coating method is also known in the art.

All of these methods have, however, various drawbacks. For example, in a melt immersion method, large amounts of heat are transferred from the hot bath of molten zinc into the hardened structure of the steel component and can significantly reduce the strength thereof. The layer thickness has limits with respect to its minimum and the coated steel cannot be welded or can be welded only with difficulty. Thus the melt immersion method is only a possibility in principal and in practice cannot be used for hot-formed hardened structural and safety components.

The spraying of the hot formed and hardened components with zinc flakes by the so-called Deltatone process produces a coating with limited adhesion and does not allow the coating of undercut regions and recessed formations except with significant expense. The coating of interior sides is practically impossible. The result is an unsatisfactory or insufficient corrosion protection. A zinc flake coating likewise is only limitedly weldable.

Thermal spray coatings likewise can have poor adhesion and poor weldability. In the case of electrolytic zinc coatings, there is the danger of hydrogen embrittlement of products with a strength in excess of 1000 MPa. Strengths in excess of 1000 MPa are rapidly exceeded with hot formed and hardened structural components of high-strength steels. Electrolytic zinc coatings and cold gas coatings are too expensive for the most part for mass production.

EP 101 3785 describes a method in which steel strip is produced with an aluminum immersion coating and then a blank cut from the coated strip is heated, hot-formed and possibly treated subsequently. The melt immersion coating forms an intermetallic phase with the steel and the hot forming and subsequent hardening do not detrimentally affect the coating. However, the cut edges of the blank do not have the protective coating and if the product is to be cold formed subsequently, the coating can be damaged. In general, the corrosion resistance of the blank is unsatisfactory.

### OBJECTS OF THE INVENTION

It is, therefore, the principal object of the present invention to provide a hot-formed and hardened structural or safety component of an automotive vehicle of high-strength steel which has a corrosion protective layer free from gaps, which suffers no diminution in strength or only little diminution in strength as a result of the corrosion protection in which the protective layer is highly adherent and weldable, and can be used even in the case of undercuts, recessed portions and internal surfaces.

Another object is to provide an improved structural or safety component of steel for a motor vehicle which has improved corrosion resistance.

It is also an object of the invention to provide an improved method of making such a component and an improved method of imparting corrosion resistance to such a component.

### SUMMARY OF THE INVENTION

These objects are attained, in accordance with the invention by providing a corrosion resistant layer in a solid state diffusion process to produce a zinc/iron alloy with a layer thickness of at most 10 μm but of a thickness sufficient to resist corrosion. The minimum thickness can be 0.01 μm.

More particularly, a method of making a structural or safety component of a motor vehicle comprises the steps of:
(a) die shaping of a blank of high-strength steel to form the component in a press;
(b) hardening the component in the press; and
(c) forming a corrosion-resistant layer on the die-shaped press-hardened component of step (b) by subjecting the component to a solid-diffusion process on the surfaces of the component to produce a zinc/iron alloy layer thereon of a thickness sufficient to resist corrosion and ≦10 μm.

The hot-formed press hardened structural or safety component will thereby comprise a corrosion-resistant layer on the die-shaped press-hardened component formed by subjecting said component to a solid-diffusion process on the surfaces of said component to produce a zinc/iron alloy layer thereon of a thickness sufficient to resist corrosion and ≦10 μm.

In another aspect of the invention, the method of increasing the corrosion resistance of the hot-formed, press-hardened structural or safety component comprises forming a corrosion-resistant layer on the die-shaped press-hardened component by subjecting the component to a solid-diffusion process on the surfaces of the component to produce a zinc/iron alloy layer thereon of a thickness sufficient to resist corrosion and ≦10 μm.

The starting point for the invention is the well known sheradization process which in the past has been practiced with bulk products like screws and bolts. Reference can be made in this regard to German Industrial Standard DIN 13811 entitled zinc diffusion coating on iron materials. Reference can also be had to U.S. Pat. No. 6,171,359. Sheradization is a solid state diffusion process in which the articles are brought into close contact with zinc dust and an inert material, for example, sand and is heated to form a zinc/iron alloy on the surface. The materials subjected to sheradization in DIN 13811 is an unalloyed carbon steel or a low alloy steel. The method is usually carried out in a slowly rotating closed vessel at a temperature of 320° through 500° C. The coating protects the iron articles from corrosion and wear and in accordance with the German Industrial Standard must have a minimum thickness of 15 μm. The coating is usually subjected to a phosphate or chromate treatment for passivation and yields a clean passivated surface. The coating follows the contours of the article with precision and enables uniform coating even of articles which have an irregular shape. The sheradized coating is a zinc/iron alloy which has high surface hardness and high wear resistance. Scratches by contact with other articles are usually only superficial and have not advance affect on the corrosion resistance. The adhesion of the coating with the substrate is strong and a characteristic of sheradization.

The good adhesion and corrosion resistance of the coating as well as the precision with which it follows the contours of the shaped article make the sheradization coating of considerable value for the hot formed and hardened vehicle components of the invention. We have found, however, in spite of teachings to the contrary, that the normal minimum coating thickness of 15 microns is totally unsuitable for the structural and safety components of the invention for which a maximum coating thickness of 10 μm is essential to permit welding and for other reasons. Because the coating is also not passivated in accordance with the invention, it can remain conductive and can enable electronic welding techniques is such as spot welding to be utilized. Other welding processes like MIG or MAG welding processes can be used. The coatings can, if required, be lacquered.

According to a feature of the invention, the article to be coated should be rotated in a drum and it has been found to be advantageous to anchor the article in the drum by an appropriate framework. Otherwise, dimensional stability cannot be insured within the necessary narrow tolerances.

Alternatively, the component to be sheradized should be placed in a stationary heating chamber and the zinc powder or powder mixture should be dispensed uniformly over the article, e.g. by nozzles so that the coating is carried out from all sides. This insures the coating of undercuts, interior walls or other surfaces which may be difficult to coat.

The component should be sheradized so that the temperature in the interior of the component by heat abstraction from the coating material should not exceed 320°.

According to a feature of the invention, the material treated may be a boron alloy steel which can have the composition in weight % of

| | |
|---|---|
| carbon | 0.18 to 0.3% |
| silicon | 0.1 to 0.7% |
| manganese | 1.0 to 2.5% |
| phosphorus | max. 0.025% |
| chromium | up to 0.8% |
| molybdenum | up to 0.5% |
| sulfur | max. 0.01% |
| titanium | 0.02 to 0.05% |
| boron | 0.002 to 0.005% |
| aluminum | 0.01 to 0.06% |

balance iron and usual smelting-related impurities.

After hot forming and hardening, this steel has an elastic limit R_{p0.2} which is ≧950 MPa, a tensile strength Rₘ and an elongation A5≧8%.

At 320°, the formation of the corrosion resistant coating can be effected without substantial adverse effect on the strength. The following steel composition in weight % can also be used:

| | |
|---|---|
| carbon | 0.09 to 0.13% |
| silicon | 0.15 0.30% |
| manganese | 1.10 1.60% |
| phosphorus | max. 0.015% |
| chromium | 1.00 to 1.60% |
| molybdenum | 0.30 to 0.60% |
| sulfur | max. 0.011% |
| vanadium | 0.12 to 0.25% |
| aluminum | 0.02 to 0.05% |

balance iron and usual smelting-related impurities.

This steel has a tensile strength Rₘ≧950 MPa, a yield point Rₚ₀₂ of ≧700 MPa and an elongation A5 of ≧14% in an air hardened state. This type of steel also hardens in air. However, to avoid varying the strength characteristic, the coating process is carried out at a temperature of 320° C. in zinc dust and sand.

The structural or safety component of the invention which results from this method has a high shape precision and good material properties like high-strength and ductility. With the system of the invention, it also has an extraordinary corrosion resistance by comparison with other techniques since the diffused layer has excellent adhesion, high wear resistance and hardness. The coating can be found to be effective on undercuts and interior surfaces as well as upon the edges of the workpiece. The workpiece can be easily welded and lacquered.

### BRIEF DESCRIPTION OF THE DRAWING

The above and other objects, features, and advantages will become more readily apparent from the following description, reference being made to the accompanying drawing in which:

FIG. 1 is an elevational view of a B column of a vehicle to which the invention is applicable;

FIG. 2 is a perspective view in highly diagrammatic form and partly broken away showing the corrosion treatment of the B column of FIG. 1; and

FIG. 3 is a block diagram illustrating the method of the invention.

### SPECIFIC DESCRIPTION

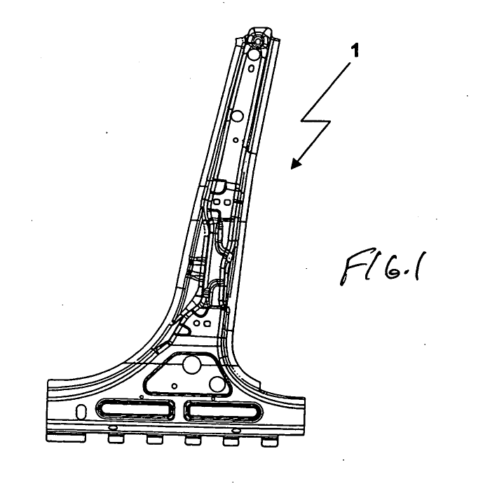

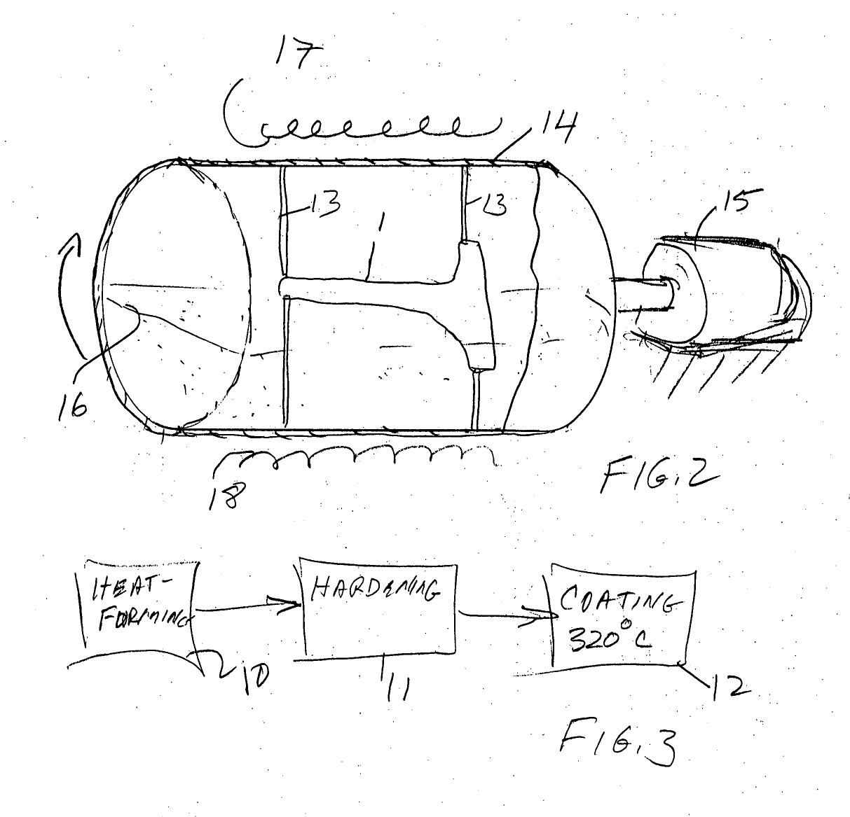

FIG. 1 shows a B column of a passenger vehicle with complex geometry. The B column serves as a structure and safety component between the front door of a vehicle and the rear passenger compartment.

The B column 1 must, in the case of side impact or a crash of some other type, guarantee the stability of the passenger compartment and thus take up significant force, resist rupture and yield to absorb the impact. It is as a result, fabricated from a hardenable steel and especially a sheet steel. In order to import the desired configuration with precision and to insure that the material will have the desired characteristics, it is heat formed in a press between dies in the hot-forming step 10 of FIG. 3 and while in the die is hardened at 11. The in-tool hardening is effected by passing a liquid coolant through the dies. Alternatively, it can be cold formed in a number of steps and only in the last step heated to a temperature above the A_{c3} temperature and pressed to its final shape in the hot-forming die, where upon the hardening is carried out in the die as has been described. After hardening, the workpiece is subjected to sheradizing coating in step 12 (FIG. 3) at say 320° C. For this purpose, the workpiece 1 is mounted in a framework 13 of a slowly rotatable drum 14 driven by a motor 15 and contacted with a zinc/sand powder mixture 16 while heated to the sheradizing temperature utilizing the heaters represented diagrammatically at 17 and 18. The coating is formed to a thickness of say 5 μm and consists of a zinc-iron alloy formed by the diffusion of zinc into the steel surface.

1. A method of making a structural or safety component of a motor vehicle which comprises:
(a) die shaping of a blank of high-strength steel to form said component in a press;
(b) hardening the component in said press; and
(c) forming a corrosion-resistant layer on the die-shaped press-hardened component of step (b) by subjecting said component to a solid-diffusion process on the surfaces of said component to produce a zinc/iron alloy layer thereon of a thickness sufficient to resist corrosion and ≦10 μm.

2. The method defined in claim 1 wherein said layer is not passivated.

3. The method defined in claim 1, further comprising the step of lacquering said layer.

4. The method defined in claim 1 wherein said steel has substantially the following composition in weight percent:

| | |
|---|---|
| carbon | 0.18 to 0.3% |
| silicon | 0.1 to 0.7% |
| manganese | 1.0 to 2.5% |
| phosphorus | max. 0.025% |
| chromium | up to 0.8% |
| molybdenum | up to 0.5% |
| sulfur | max. 0.01% |
| titanium | 0.02 to 0.05% |
| boron | 0.002 to 0.005% |
| aluminum | 0.01 to 0.06% |

balance iron and usual smelting-related impurities.

5. The method defined in claim 1 wherein said steel has substantially the following composition in weight percent:

| | |
|---|---|
| carbon | 0.09 to 0.13% |
| silicon | 0.15 to 0.30% |
| manganese | 1.10 to 1.60% |
| phosphorus | max. 0.015% |
| chromium | 1.00 to 1.60% |
| molybdenum | 0.30 to 0.60% |
| sulfur | max. 0.011% |
| vanadium | 0.12 to 0.25% |
| aluminum | 0.02 to 0.05% |

balance iron and usual smelting-related impurities.

6. A hot-formed, press-hardened structural or safety component of a motor vehicle which comprises a corrosion-resistant layer on the die-shaped press-hardened component formed by subjecting said component to a solid-diffusion process on the surfaces of said component to produce a zinc/iron alloy layer thereon of a thickness sufficient to resist corrosion and ≦10 μm.

7. The hot-formed, press-hardened structural or safety component of a motor vehicle defined in claim 6 wherein said layer is not passivated.

8. The hot-formed, press-hardened structural or safety component of a motor vehicle defined in claim 6, further comprising a lacquer coating on said layer.

9. The hot-formed, press-hardened structural or safety component of a motor vehicle defined in claim 6 wherein said steel has substantially the following composition in weight percent:

| | |
|---|---|
| carbon | 0.18 to 0.3% |
| silicon | 0.1 to 0.7% |
| manganese | 1.0 to 2.5% |
| phosphorus | max. 0.025% |
| chromium | up to 0.8% |
| molybdenum | up to 0.5% |
| sulfur | max. 0.01% |
| titanium | 0.02 to 0.05% |
| boron | 0.002 to 0.005% |
| aluminum | 0.01 to 0.06% |

balance iron and usual smelting-related impurities.

10. The hot-formed, press-hardened structural or safety component of a motor vehicle defined in claim 6 wherein said steel has substantially the following composition in weight percent:

| | |
|---|---|
| carbon | 0.09 to 0.13% |
| silicon | 0.15 to 0.30% |
| manganese | 1.10 to 1.60% |
| phosphorus | max. 0.015% |
| chromium | 1.00 to 1.60% |
| molybdenum | 0.30 to 0.60% |
| sulfur | max. 0.011% |
| vanadium | 0.12 to 0.25% |
| aluminum | 0.02 to 0.05% |

balance iron and usual smelting-related impurities.

11. A method of increasing corrosion resistance of a hot-formed, press-hardened structural or safety component of a motor vehicle, which comprises forming a corrosion-resistant layer on the die-shaped press-hardened component by subjecting said component to a solid-diffusion process on the surfaces of said component to produce a zinc/iron alloy layer thereon of a thickness sufficient to resist corrosion and ≦10 μm.

12. The method defined in claim 11 wherein said layer is not passivated.

13. The method defined in claim 11, further comprising the step of lacquering said layer.

14. The method defined in claim 11 wherein said steel has substantially the following composition in weight percent:

| | |
|---|---|
| carbon | 0.18 to 0.3% |
| silicon | 0.1 to 0.7% |
| manganese | 1.0 to 2.5% |
| phosphorus | max. 0.025% |
| chromium | up to 0.8% |
| molybdenum | up to 0.5% |
| sulfur | max. 0.01% |
| titanium | 0.02 to 0.05% |
| boron | 0.002 to 0.005% |
| aluminum | 0.01 to 0.06% |

balance iron and usual smelting-related impurities.

15. The method defined in claim 11 wherein said steel has substantially the following composition in weight percent:

| | |
|---|---|
| carbon | 0.09 to 0.13% |
| silicon | 0.15 to 0.30% |
| manganese | 1.10 to 1.60% |
| phosphorus | max. 0.015% |
| chromium | 1.00 to 1.60% |
| molybdenum | 0.30 to 0.60% |
| sulfur | max. 0.011% |
| vanadium | 0.12 to 0.25% |
| aluminum | 0.02 to 0.05% |

balance iron and usual smelting-related impurities.

16. The method defined in claim 11 wherein said component is fixed in a heating chamber and is coated with a sherandizing powder of zinc on all sides at a temperature below 320° C.
